(19) United States
(12) Patent Application Publication
(10) Pub. No.: US 2012/0189712 A1
(43) Pub. Date: Jul. 26, 2012

(54) PROCESS OF USE OF IONS IN AGRICULTURE, ANIMAL AND HUMAN HEALTH

(76) Inventor: Milton de Moura Muzel, Itapeva (BR)

(21) Appl. No.: 13/390,051

(22) PCT Filed: Jul. 27, 2010
(86) PCT No.: PCT/BR2010/000243

§ 371 Date: Apr. 12, 2012

(30) Foreign Application Priority Data
Aug. 11, 2009 (BR) BR-PI-0902837-4

(51) Int. Cl. A01N 59/20; A01P 1/00; B05B 17/00; A23K 1/18; A23L 1/304; A01P 3/00; C05D 9/02

(52) U.S. Cl. 424/630; 71/31; 426/2; 239/1

(57) ABSTRACT

“Process of use of ions in agriculture, animal and human health”, it is intended to enable the utilization of ions, cations especially, with biocide purposes, with micronutrient functionality, as microelement to maintain biosecurity, obtained from the process of ionization in aqueous saline solution directed to agriculture and the areas of human and animal health.

This patent of invention request realates to a new “Process of use of ions in agriculture, animal and human health”, especially a process for producing ions, particularly the cations, with biocide purposes, with micronutrient functionality, as microelement to maintain biosecurity, obtained from the process of ionization in aqueous saline solution directed to agriculture and the areas of human and animal health.

### BACKGROUND OF INVENTION

The fundamental difficulty viewed by the inventor of this patent are the use of chemical elements in the molecular form, for various purposes above mentioned and which will be outlined in greater detail throughout this report. The molecular form shows that the limits disadvantage the maximum efficiency of the active chemical ingredients.

### TECHNICAL FOUNDATION

To understand the system in its entirety, in which the process of ionization occurs, it is necessary to point out some elements that that bring definitions to complement this understanding.

Humphry DAVY (★1778-†1829) it was the precursor in the studies that stimulated the development of Electrochemistry—extent to which this proposal is fully immersed.

Michael FARADAY (★1791†1867), English chemist and physicist, was pupil and successor of Davy in Royal Institution of Great Britain (London-England), adding years after the legal elements which make up the foundation on which this paper fits and compounding the electrochemical understanding up to today. These legal elements formulated by the scientist takes its name: Faraday's Law. Complementing the theoretical foundation in the historical context of Electrochemistry, it is pointed out the etymology of the word ion—first used by Faraday. This word comes from Greek ion and comprises a particle of the verb (grego) eîmi, meaning: go, walk. Therefore, there is the essence of the lexical unit “ion” exactly what happens in the process of ionization (or electrolysis), in that the ion —positively or negatively charged—‘walks’ from one pole to another, according to the reaction outlined in particular solution.

Electrolysis—discovery and tested by Davy and then theoretically described by Faraday, it is the production of a chemical reaction by passing a continuous stream through an electrolyte, in other words, a compound containing ions (atom or group of them who become through the process of the above elements electrically charged by the gain or loss of electrons) in solution.

### FIELD OF APPLICATION

Applications that deal with this patent document fall into three segments:

### Agriculture/Nutrition:

It is known that minerals are essential to the maintenance of life and they can be related to all diseases or dysfunctions of living organisms due to their deficiencies. Mineral is a material in natural solid form (with some exceptions), inorganic, that composes the lithosphere (HOUAISS, 2001). Using the periodic table (MENDELEIEV, 1834-1907) as reference to explain about the minerals, they have: alkali metals, the alkaline earth metals, the transition metals, the lanthanides and actinides, among other metals. Those who do not fall into the category of minerals are: the non-metals and noble gases.

By emphasizing the importance of micronutrients in agriculture, it is mentioned the intrinsic parts related to minerals, because these compounds the trace elements necessary for the maintenance of the practices of sustainable agriculture. The main reasons for the establishment of the importance of micronutrients are (LOPES, 1999):

the beginning of the occupation of the Brazilian Cerrado, composed of soils deficient in micronutrients naturally;

the increasing of the productivity of several crops with higher removal and export of all nutrients;

the inadequate incorporation of limestone or the use of high doses, accelerating the beginning of induced defects;

the increasing of the rate of production and use of NPK fertilizers of high concentration, reducing the incidental content of micronutrients in such products;

the improvement of soil and foliar analysis as tools for diagnosis of micronutrient deficiencies.”

### Agriculture/Biocide:

Among the chemical elements potentially effective in combating the pathogens responsible for diseases in agriculture, copper has a prominent role, acting specifically as a fungicide and bactericide. As already explained, to achieve the required value that results in disease control, it is necessary to provide large amounts of copper molecules, particularly sulphates, oxichlorides and hydroxides.

Another important addition to the element Cu is in its sustainable promoting, when it is delimited to ionic use, since the volume of copper used in obtaining these ions is negligible compared to the volume of copper sulphates (molecular form) used as a biocide.

This application proposes the provision of copper ion as a biocide, promoting optimal lethal dose that does not harm nor promotes resistance to microorganisms, which, at maximum doses, but with minimal absorption, result in selectivity of bacterial groups, hindering the future control of diseases in many crops.

Copper itself has a direct effect on fungi and bacteria, either avoiding or suppressing the germination of spores, or inhibiting plant growth, or restricting the multiplication of bacterial cells. In the biocidal context, copper participates indirectly, stimulating the production of phytoalexins, or natural inducers of resistance. This compound, when appropriate amount in the plant, which may be achieved by the method presented herein, allows the reducing of formation of peroxidases, and consequent accumulation of peroxide. Such component has importance and properties fungicide and fungistatic, and bactericidal and bacteriostatic. Moreover, when appropriate amount, it participates in the physiology of ethylene, which triggers the necessary mechanisms for gene expression and consequent production of inducers of resistance.

Inducers of resistance are active substances in physiological concentrations, of systemic and not systemic activities, able to perform short and long distances in the plant tissues, with durability of weeks or even months.

### Human Health/Nutrition:

It is known about the elements that comprise the Periodic Table, that approximately 50 of them are present in the human body. The lack of this elements-trace has been seen in individuals, due to decreased bioavailability of trace elements in food produced by the current model of agriculture.

“The result is that, although the minerals, both macro and micro, are present in the food, they are much smaller than should be and their bioavailability and ability of biological activity is lower. Also the industrialization of food adds to them many chemical additives (colorants, flavorants, preservatives, acidulents, stabilizers, etc), which are molecules with chelating ability, or scavenging of minerals, reducing the organic contribution, mainly of microminerals” BONTEMPO, 2009.

One of the issues in the context of human health that this process can contribute is precisely the following: even make the replacement of micronutrient to the use of organic foods, integrals this does not mean that assimilation is plausible and the supplementation of trace elements is not feasible, as presented BONTEMPO (2009).

“. . . it is not find in the regular commerce calcium, magnesium or zinc in atomic or ionized form, but these elements combined, such as calcium carbonate, magnesium chloride, zinc oxide, etc”.

It is known that the cell uptake occurs through the ion and micronutrients on the market today are not in that form.

TABLE
Micronutrients essential to human body.

| | | | ATOMIC | ATOMIC | BOILING | | MELTING | | | | |
|---|---|---|---|---|---|---|---|---|---|---|---|
| SYMBOL | NAME | GROUP | N°. | MASS | POINT | | POINT | | DENSITY | | OXIDATION |
| B | Boron | Non- | 5 | 10.811 | 2.550° | C. | 2.300° | C. | 2.34 | g/mL | 3⁺ |
| | | metals | | | | | | | | | |
| Co | Cobalt | Transition | 27 | 58.933 | 2.900° | C. | 1.495° | C. | 8.9 | g/mL | 2⁺ 3⁺ |
| | | metal | | | | | | | | | |
| Cr | Chrome | Transition | 24 | 51.996 | 2.665° | C. | 1.875° | C. | 7.19 | g/mL | 2⁺ 3⁺ 6⁺ |
| | | metal | | | | | | | | | |
| Cu | Copper | Transition | 29 | 63.54 | 2.595° | C. | 1.083° | C. | 8.96 | g/mL | 1⁺ 2⁺ 3⁺ |
| | | metal | | | | | | | | | |
| Fe | Iron | Transition | 26 | 55.847 | 3.000° | C. | 1.536° | C. | 7.86 | g/mL | 2⁺ 3⁺ 4⁺ 6⁺ |
| | | metal | | | | | | | | | |
| Ge | Germanium | Another | 32 | 72.59 | 2.830° | C. | 937.4° | C. | 5.32 | g/mL | 4⁺ |
| | | Metal | | | | | | | | | |
| I | Iodine | Non- | 53 | 126.904 | 183° | C. | 113.7° | C. | 83.4 | g/mL | 1⁺ 5⁺ 7⁺ |
| | | metal | | | | | | | | | |
| Li | Lithium | Alkali | 3 | 6.939 | 1.330° | C. | 108.5° | C. | 0.53 | g/mL | 1⁺ |
| | | metal | | | | | | | | | |
| Mn | Manganese | Transition | 25 | 54.938 | 2.150° | C. | 1.245° | C. | 7.43 | g/mL | 2⁺ 3⁺ 4⁺ 6⁺ |
| | | metal | | | | | | | | | 7⁺ |
| Mo | Molybdenum | Transition | 42 | 95.94 | 5.560° | C. | 2.610° | C. | 10.2 | g/mL | 2⁺ 3⁺ 4⁺ 5⁺ |
| | | metal | | | | | | | | | |
| Ni | Nickel | Transition | 28 | 58.71 | 2.730° | C. | 1.453° | C. | 8.9 | g/mL | 2⁺ 3⁺ |
| | | metal | | | | | | | | | |
| Rb | Rubidium | Alkali | 37 | 85.47 | 688° | C. | 38.9° | C. | 1.53 | g/mL | 1⁺ |
| | | metal | | | | | | | | | |
| Se | Selenium | Non- | 34 | 78.96 | 685° | C. | 217° | C. | 4.79 | g/mL | 4⁺ 6⁺ |
| | | metal | | | | | | | | | |
| Sr | Strontium | Alkaline | 38 | 87.62 | 1.380° | C. | 768° | C. | 2.6 | g/mL | 2⁺ |
| | | earth | | | | | | | | | |
| | | metal | | | | | | | | | |
| Sn | Tin | Other | 50 | 118.69 | 2.270° | C. | | | 7.3 | g/mL | 2⁺ 4⁺ |
| | | metals | | | | | | | | | |
| V | Vanadium | Transition | 23 | 50.942 | 3.450° | C. | 1.900° | C. | 6.1 | g/mL | 2+ 3+ 4+ 5+ |
| | | metal | | | | | | | | | |
| Zn | Zinc | Transition | 30 | 65.37 | 906° | C. | 419.5° | C. | 7.14 | g/mL | 2⁺ |
| | | metal | | | | | | | | | |

### Human Health/Biosecurity:

Biosecurity is an interdependent process (functional, operational and behavioral) which seeks to control infections that benefits both the operator and the user of health services. There are standard precautions to take effect in health practice to minimize the risk of infection. The routine washing of hands is an essential element to this maintenance.

“. . . germs adhered into hands are passed on to other objects and patients, just as they can be transferred to other parts of the body, as the eyes and nose. Only washing hands with soap and water will remove these acquired germs and prevent the transfer of microbes to other surfaces”. OPPERMANN & PIRES, 2003.

In this context the use of ions that benefit human health and recognizing the biocidal property of Copper and Silver, the principle here pleaded can be used in faucets and drinking fountains.

### Animal Health:

Minerals are of great importance in animal health. In general, these microelements are part of the tissue. On the other hand, minerals also act as electrolytes, performing maintenance of acid-base balance, and regulating the osmotic pressure and cellular permeability. Another essential function is the responsibility for the activation of enzymatic processes.

In livestock, diets consumed by the animals do not match, generally, to the needs required for the balanced development of these animals and this deficiency in the availability of micronutrients worries ranchers.

“According to current knowledge, of about 50 minerals that the body contains, the trace elements essential to metabolic processes and that must be present in food are: Iron (Fe), Cobalt (Co), Copper (Cu), Iodine (I), Manganese (Mn), Zinc (Zn) and Selenium (Se) ( . . . )these are required to the animals in very small quantities. Lately, other minerals have been added to the list above, as Fluorine (F), Molybdenum (Mo), Chrome (Cr), Nickel (Ni), Vanadium (V) and Silicon (Si)”. TOKARNIA, DOBEREINER, & PEIXOTO, 2000.

One of the forms used by farmers so that the supplementation, due to lack of micronutrients, is effective is the use of a mineral mixture allegedly ‘complete’. The indiscriminate use of these components disqualifies supplementation, since, in taking such an attitude without a precise and individualized diagnosis of the squad, some imminent dangers are envisioned.

The terminology ‘complete’, related to mineral mixtures, indicates the aggregate of more micronutrients possible. When deciding for their conduct without further investigation, is liable to supplement without needed, because there are regions that supplementation is not indicated and, as a result of, there is waste of minerals. Another noted risk is the danger of the interferences, when there is introducing of some existing trace element, making it excessive, and they destabilize the metabolism of the animal. The absence, on the other hand, of trace elements results in great difficulties for a herd, in the same way as the excess unbalances it.

Given this context, this invention drives micronutrient supplementation in animal health, adding ions of trace elements essential for water used in the squad, reducing costs, and adjusting the specific needs of the herd, the quantity diagnosed by specialist.

### Of the State of Technique

Given the context related to agriculture, is that current methods of micronutrient replacement are performed under the molecular form. Thus, initially the plant absorbs trace elements arranged in this way, but it captures the minimum due to its own molecular arrangement. Next, the plant performs the transport of micronutrients in order to be distributed at the cellular level and so, there is real assimilation of the essential elements for maintaining the overall health of the plant. For the cell entry, a trace element is needed to be found in ionic form, preferably. During the entire process, from the absorption, passing through the transport and culminating in cell entry or distribution, elements are lost due to certain factors, as:

soil conditions (texture, structure, moisture, pH) and how these nutrients are available. These are absolutely relevant, since, through its plant-available form, they reach the cellular levels to a greater or lesser extent, and result in higher or lower plant nutrition, directly influencing their metabolism.

“The transport of a substance through the membrane (cellular) depends on its size and polarity. Nonpolar or very small substances usually pass freely through the membrane. However, most of the molecules (with elements necessary for the cell) are polar. The transport of polar molecules is done with the aid of carrier proteins present in the membranes, named channels, carriers and pumps. The channels, for example, transport ions by the simple opening of a pore. An open channel may allow passage of 10⁸ ions/s ( . . . )The channels are limited to ions and water . . . ” DOS SANTOS, 2004.

According to table below, they are describe some trace elements that can be used in ionic form which present essentiality to animal nutrition:

TABLE
Chemical elements relevant to plant nutrition.

| | | | ATOMIC | ATOMIC | BOILING | | MELTING | | | | |
|---|---|---|---|---|---|---|---|---|---|---|---|
| SYMBOL | NAME | GROUP | NUMBER | MASS | POINT | | POINT | | DENSITY | | OXIDATION |
| Al | Aluminum | Other | 13 | 26.9815 | 2.450° | C. | 660° | C. | 2.70 | g/mL | 3⁺ |
| | | metals | | | | | | | | | |
| B | Boron | Non- | 5 | 10.811 | 2.550° | C. | 2.300° | C. | 2.34 | g/mL | 3⁺ |
| | | metals | | | | | | | | | |
| Co | Cobalt | Transition | 27 | 58.933 | 2.900° | C. | 1.495° | C. | 8.9 | g/mL | 2⁺ 3⁺ |
| | | metal | | | | | | | | | |
| Cu | Copper | Transition | 29 | 63.54 | 2.595° | C. | 1.083° | C. | 8.96 | g/mL | 1⁺ 2⁺ 3⁺ |
| | | metal | | | | | | | | | |
| Fe | Iron | Transition | 26 | 55.847 | 3.000° | C. | 1.536° | C. | 7.86 | g/mL | 2⁺ 3⁺ 4⁺ 6⁺ |
| | | metal | | | | | | | | | |
| Mn | Manganese | Transition | 25 | 54.938 | 2.150° | C. | 1.245° | C. | 7.43 | g/mL | 2⁺ 3⁺ 4⁺ 6⁺ |
| | | metal | | | | | | | | | 7⁺ |
| Mo | Molybdenum | Transition | 42 | 95.94 | 5.560° | C. | 2.610° | C. | 10.2 | g/mL | 0, 2⁺ 3⁺ 4⁺ |
| | | metal | | | | | | | | | 5⁺ |
| Na | Sodium | Alkali | 11 | 22.9898 | 892° | C. | 97.8° | C. | 0.97 | g/mL | 1⁺ |
| | | metal | | | | | | | | | |
| Ni | Nickel | Transition | 28 | 58.71 | 2.730° | C. | 1.453° | C. | 8.9 | g/mL | 2⁺ 3⁺ |
| | | metal | | | | | | | | | |
| Si | Silicon | Non- | 14 | 289.086 | 2.680° | C. | 1.410° | C. | 2.42 | g/mL | 4⁺ |
| | | metal | | | | | | | | | |
| Zn | Zinc | Transition | 30 | 65.37 | 906° | C. | 419.5° | C. | 7.14 | g/mL | 2⁺ |
| | | metal | | | | | | | | | |

“In plant, copper is present in the form of three proteins: (i) blue proteins, which do not have oxidase activity (ex, plastocyanin); (ii) non-blue proteins, non-blue proteins, which produce peroxidases and oxidize the monophenol and diphenol compounds; and (iii) multi-copper proteins, which contain at least four copper atoms per molecule, which act as oxidases (ex. ascorbate oxidase and laccase) and catalyze the reaction 2AH₂+O₂→2A+2H₂O. The cytochrome oxidase is a mixture of protein comprised of copper and iron, which catalyzes the terminal oxidation in the mitochondria. Under conditions of copper deficiency, copper protein activity decreases dramatically, with large physiological losses”. BERNARD KNEZEK, 1997.

Overall, Copper in particular is critical to the activity of several proteins, essential for the proper functioning of the plant, including photosynthesis, nitrogen metabolism, formation and accumulation of carbohydrates and differentiation processes, including tissue lignification. A lignificação em si é fundamental para a resistência fisica dos tecidos.

### Of the Invention

It relates to a process that makes use of ions in the agriculture, animal and human health, by providing micronutrients, or as to the biocide action, or the provision of microelements to promote biosafety, resulting from the ionization process that occurs in the chemical elements in saline solution and activated by electric current.

### OBJECT OF INVENTION

In this patent, which is aiming is the best result, greater potentiation and stabilization of the expected effects of the active chemical elements on living organisms, with the least possible use of resources. This goal can be achieved with the use of ions with positive charge, due it is known of the technician in the subject matter and scientifically proven that the ideal form to process the effective absorption of trace elements by living organisms is the ionic form and not the molecule form.

The proposal of using of ion to be applied in an agricultural context, and in animal and human health, aiming at the completeness of each of these objectives is strictly relevant, since it has been considered the scarcity of natural products. So, this patent application develops sustainable management of operations and activities that require the use of natural resources, culminating in effective costs reduction.

Basically, the invention is based on the fact that trace amounts, in other words, small and necessary portions absorbable by living organisms, essential to life, are nanoelements in ionic form.

### Agricultural Sample

Use of molecular copper to combat the blight, scab and melanosis x use of ionized copper.

In a citrus orchard, use is made of copper molecular to combat the blight, scab and melanosis, by model advocated internationally. For this representation, each tank used in the spray has the capacity to 2000 l of liquid. The molecular mass of copper (salts) corresponds to 5 g/l and, by plant, it is found the equivalent to 10 g. The flow in the spray reaches 1,11 l/s.

In particular citrus orchard, located in the southwest of São Paulo State, it was delimited 22995 plants treated with the same purpose described in the preceding paragraph, but using ionized copper. The same tank with capacity to 2000 l of liquid was used, however a particular ionizer was coupled to the spray machine. They were used 44000 l of liquid to cover the quoted number of plants within a period of eleven hours. The ionizer had copper cylinders weighing 5.260 g initially. At the end of the application of ionized copper, the weight of copper was reduced to 5.120 g, representing a consumption of 140 g of copper. So, the mass of copper in ionic form applied per plant was 0,0032 g/l and the mass of copper in ionic form applied by plant corresponded to 0,0064 g, with the same flow of 1,11 l/s.

In time, the two methods of application were effective in combating diseases.

Comparing the two methods, the conventional form of application of molecular copper per liter applied, in this example, in a citrus orchard, is about 1.562,5 times higher compared to spraying with ionized copper.

### Advantages of the Invention

the amount of copper in the molecular form required for the desired purpose, being in the nutrition or as a biocide, is much greater than the ionic amount, because this is the form preferentially absorbed by plant;

in the case of biocide action, the applied quantity is crucial by selectivity that microorganisms held on of drugs, particularly in high doses with minimal absorption, resulting in bacteria, for example, resistant to treatment, denoting future problems to culture, reducing the spectrum of chemical elements applied for the same combat;

another key component of the producer, in this example, citrus, refers to high maintenance costs for the orchard, since the percentage used with micronutrients, and biocide action, correspond to 70 and 75% of total cost, thus, this invention can contribute of absolutely relevant manner in this regard, optimizing this ratio, creating new spaces for technology investments, which, in principle, only the major producers would have access.

In order to better illustrate the aforesaid, follow the figures listed below, of an illustrative and not limited way:

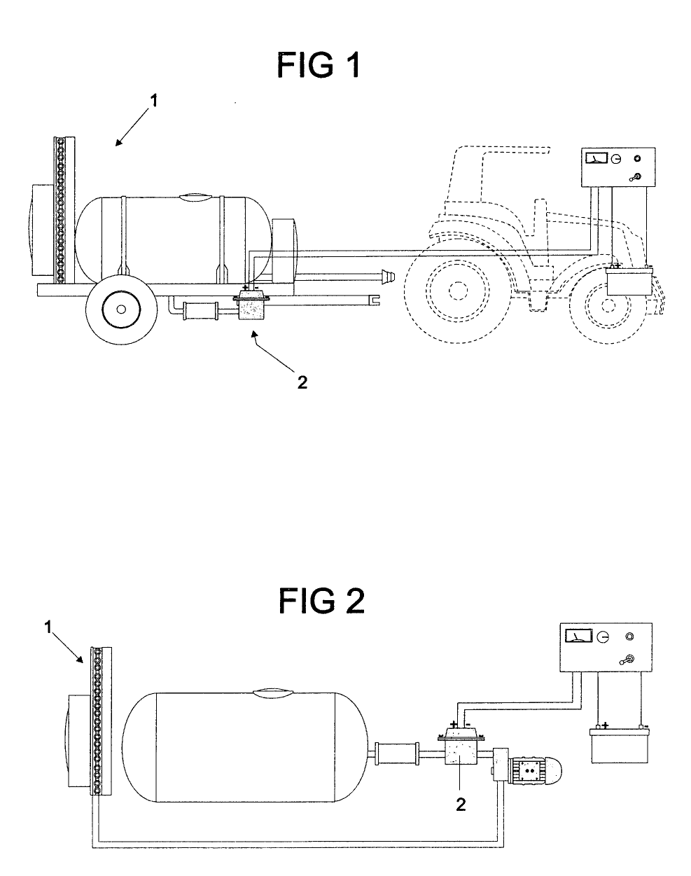

FIG. 1: Schematic view of the application of the process of use of ions in the agriculture;

FIG. 2: Detail of the application of the process of use of ions in the agriculture.

The Process of use of ions in agriculture, animal and human health, object of this Patent of Invention request, is intended to enable the utilization of ions, cations especially, with biocide purposes, with micronutrient functionality, as microelement to maintain biosecurity, obtained from the process of ionization in aqueous saline solution directed to agriculture and the areas of human and animal health

The process relies on the use of ions in agriculture, animal and human health, able to provide micronutrients, or as biocide action, or the provision of microelements to promote biosafety, where each element resulting from the ionization occurs in the chemical elements in saline solution activated by electric current for various purposes, such as micronutrients for agriculture.

The uniqueness is made in the economy of used ingredients, since they fall within the core of nanoscience, since this process is part of the atom electrically charged named ion, and the ion holds the key way to maintain intrinsically the living organisms.

More particularly, in agriculture, micronutrients in ionic form are available through used spraying (1), in which a specific ionizer (2) is installed next to the spray element, which fluid, to go through the same, constricts the compounds required for plant nutrition in metallic form, where such components are dipped in saline solution ,under proper electrical load.

1. “Process of use of ions in agriculture, animal and human health”, wherein each element is the result of the ionization process occurring in the chemical elements in saline solution activated by electrical current for various purposes.

2. “Process of use of ions in agriculture, animal and human health”, according to claim 1, wherein, in agriculture, micronutrients in ionic form are available through spraying (1), in which a specific ionizer (2) is installed next to the spray element, which fluid, to go through the same, constricts the compounds required for plant nutrition in metallic form, where such components are dipped in saline solution under proper electrical load.
